(19) United States
(12) Patent Application Publication
(10) Pub. No.: US 2026/0254143 A1
(43) Pub. Date: Aug. 27, 2026

(54) CLAMPED POWER CONTACT

(71) Applicant: SAFRAN ELECTRICAL & POWER, BLAGNAC CEDEX (FR)

(72) Inventor: Pierre RAVEL, MOISSY-CRAMAYEL (FR)

(21) Appl. No.: 18/875,965

(22) PCT Filed: Jun. 14, 2023
(86) PCT No.: PCT/FR2023/050860

§ 371 Date: Dec. 17, 2024

(30) Foreign Application Priority Data
Jun. 17, 2022 (FR) FR2205956

(51) Int. Cl. H01R 13/11; H01R 13/193; H01R 13/623; H01R 13/635

(52) U.S. Cl. CPC H01R 13/111; H01R 13/193; H01R 13/623; H01R 13/635

(57) ABSTRACT

Electrical connector comprising:
a female contact (10), with a central element (12) having an inner axial housing (121), and a ring (14) arranged around said central element (12), the ring (14) being mounted so as to be moveable relative to the central element (12) with an inner wall (143) of the ring (14) delimiting an opening of constricted shape, typically conical, complementary to a profile of an outer region (125) of the central element, which can slide over this outer region, said ring (14) being connected to the central element (12) by means of an elastic element (25) arranged between the ring (14) and the central element (12) and tending to push the central element of the ring (FIG. 1A).

### TECHNICAL FIELD

The present application relates to the field of electrical connectors provided with a male contact designed to engage with a female contact. It concerns an improved connector and is applicable in particular to connectors provided to withstand high currents.

### PRIOR ART

Preserving the quality of the electrical contact between the male and female parts of a connector is all the more critical when a connector is designed to carry high currents, due to losses and overheating.

Documents U.S. Pat. No. 10,312,612B2 and CN204668541A1 disclose different electrical connector structures.

In order to improve the electrical contact, it is known to provide an elastic structure inside an inner housing for receiving a female contact and which deforms when the male contact is inserted. Such a structure ensures improved contact pressure on the male contact.

In this case, the elastic structure is a conductive material with a given stiffness. Such an elastic structure is sensitive to high temperatures and has limited performance to the extent that a balance has to be struck between its electrical properties, on the one hand, and its mechanical ones, on the other.

Another type of connector in which an external spring structure is arranged around the female contact may also be envisaged.

The female part that surrounds the male part is then made slightly deformable and the external spring structure ensures that the female part is clamped onto the male part of the electrical connector. As the spring does not have an electrical conduction function here, it may be optimised in terms of mechanical properties.

However, clamping tends to generate friction between the contact surfaces during insertion and therefore damages them if it is too tight.

Generally speaking, a compromise is sought between a contact pressure that is sufficiently high to achieve good electrical conduction between the contacts and sufficiently low so that when the male contact is inserted in order to establish a connection or when the male contact is removed during disconnection, the contact surfaces are not damaged too much.

The object is to find a new and improved electrical connector structure relative to aforementioned drawbacks.

### DESCRIPTION OF THE INVENTION

An embodiment of the present invention relates to an electrical connector comprising:
a female contact, the female contact being provided:
with a central element, internally defining an inner axial housing to receive a male contact,
said inner axial housing extending along a longitudinal axis and having a so-called “opening” area through which the male contact is designed to penetrate, and a so-called “bottom” area opposite which the male contact is designed to be located in a first position, known as the “clamped position”, of the connector,
with a ring arranged around said central element and separate from said central element, the ring being mounted so as to be moveable relative to the central element and arranged such that an inner wall of the ring is able to slide against an outer region of said central element, said inner wall of the ring delimiting an opening of constricted shape, in particular frustoconical or conical, complementary to a profile of said outer region of the central element, said constricted shape having a cross-section which decreases with movement parallel to said longitudinal axis from the opening area towards the bottom area.

Such a complementary shape prevents friction at the male/female electrical contact surfaces during connection when the male contact is inserted and during disconnection when it is removed.

In order to facilitate the insertion and removal of the male contact, an elastic element is arranged between the ring and an outer region of the central element.

The elastic element is typically in the form of at least one spring tending to push the central element.

The elastic element is typically connected to an outer region of the ring.

The male contact is received in the inner axial housing, passing through the opening area before reaching the bottom area.

The elastic element tends to push the central element of the ring when the male contact is pushed towards the bottom area of the inner axial housing of the female contact.

Advantageously, the central element of the female contact may be provided with a plurality of fingers defining at least part of the inner axial housing at its opening area, each finger having a free end, separate from the respective free ends of the other fingers and another end opposite the end and attached to a foundation.

This enables the radial flexibility of the central element of the female contact to be improved.

According to a possible embodiment, the outer region of the central element has a bulge at an upper end of the central element, said elastic element being arranged between said bulge and an upper edge of the ring. Such an arrangement takes up very little space.

According to a possible embodiment of the connector, it may be provided with a male contact having:
a conductive base opposite which an upper edge of the central element of the female contact is intended to be arranged,
a conductive rod designed to penetrate said inner axial housing, the conductive rod having a complementary shape to that of the inner axial housing, in particular a cylinder of revolution shape.

The electrical connector may typically also comprise a case for receiving the contacts. The case may be provided with a part having an inner space provided with a first volume into which the male contact is designed to be inserted and a second volume in which the female contact is designed to be housed.

The second volume typically has a cross-section smaller than that of the first volume.

The ring is advantageously moveable relative to said part of said case and attached to said part by means of a second elastic element, in particular in the form of at least one other spring. Such a second elastic element may be provided to compensate for play and expansion whilst maintaining pressure on the ring.

Advantageously, the second elastic element is attached to a second end region of the ring opposite said end region, and wherein the second volume of said part of the case is arranged between the first volume and a third volume which is narrower than the second volume, the case having a stop area around an interface area between the second volume and the third volume, said stop area being provided at said narrowing, said second elastic element being attached to said stop area.

According to a possible embodiment of the case, said part of the case has, in the first inner volume, an internal thread for receiving an external thread arranged laterally on the male contact.

Alternatively, the male contact is in a part of the case provided with a projecting area having an internal thread and the female contact in another part of the case having an external thread.

The base of the male contact may be surrounded by an envelope of insulating material and which has the external thread to enable the male contact to be screwed into said part of the case.

The central element of the female contact may be mounted to be moveable in said part of said case.

According to a possible embodiment of the electrical connection, in its clamped position, an upper end of the central element of the female contact is located in the second volume, and in a released position, an upper end of the central element of the female contact extends into the first volume.

### BRIEF DESCRIPTION OF THE DRAWINGS

The present invention will be better understood upon reading the description of exemplary embodiments provided merely for illustrative purposes and which are in no way limiting, with reference to the appended drawings wherein:

FIGS. 1A and 1B show an exemplary connector as implemented according to a embodiment of the present invention and in a first so-called “clamped” position.

FIGS. 2A and 2B show the connector in a second so-called “released” position.

FIG. 3 shows an exemplary embodiment of the case for receiving the female contact of the connector.

FIG. 4 shows an exemplary embodiment of the female contact of the connector.

Furthermore, in the description hereinafter, terms that depend on the orientation of a structure, such as “lateral”, “longitudinal”, “transverse”, etc., apply assuming that the structure is oriented as shown in the figures.

Identical, similar or equivalent parts of the different figures bear the same reference numerals so as to make it easier to switch from one figure to another.

### DESCRIPTION OF THE EMBODIMENTS

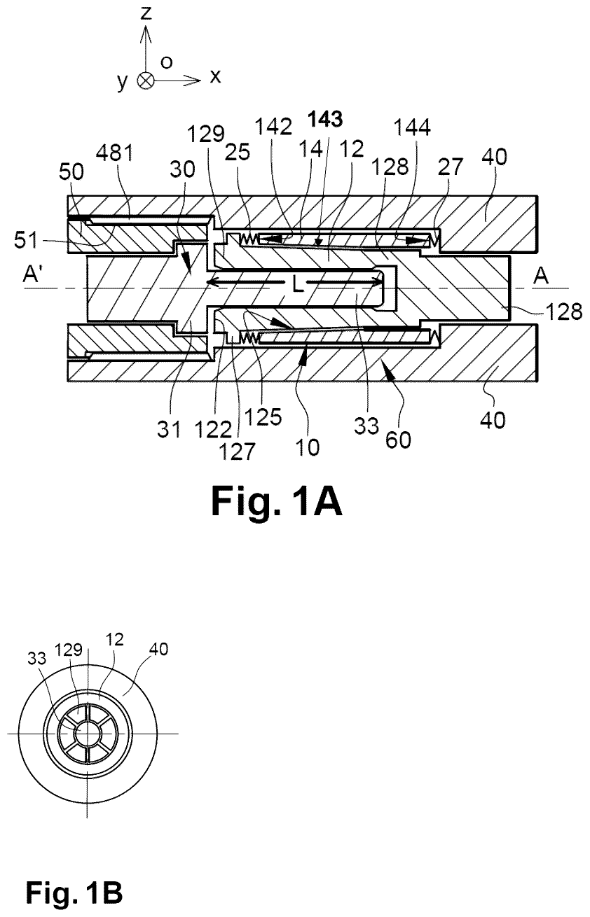

FIGS. 1A-1B (a longitudinal sectional view and a cross-sectional view respectively) show an exemplary electrical connector implemented according to an embodiment of the present invention, and which is in a first so-called “clamped” position, in which electrical contact, in particular optimal electrical contact, is ensured.

The connector may be intended for use in a voltage range which is high in particular relative to the usual voltages 28 VDC and 115 VAC commonly used in aeronautics: 500 V and more.

The connector may be used in a DC voltage range in particular, for example between 400 VDC and 2000 VDC and with a high current, in particular greater than 50 A, for example between 80 A and 1000 A.

The connector is provided with an oblong-shaped male contact 30, typically provided with a conductive rod 33 which can be in the shape of a cylinder of revolution. The conductive rod 33 has a smooth coating and is made of a metallic conductive material such as silver-plated copper.

In order to ensure electrical contact, the conductive rod 33 is inserted into an inner axial housing 121 of a female contact 10 composed of a plurality of parts (also shown purely schematically and in simplified form in FIG. 4). The axial housing 121 extends along a longitudinal axis A'A (axis which extends parallel to the x-axis of an orthogonal coordinate system [O; x; y; z] shown in the figures). In the clamped position, the male contact 30 is as close as possible to a female contact 10.

In this exemplary embodiment, the conductive rod 33 of the male contact 30 extends from a base 31 which is wider than the rod 33. A transverse surface 31A of the base 31 located around the rod 33 is intended to be placed opposite, and possibly in abutment against, or in contact with, an upper end 122 of a central element 12 of the female contact 10.

The male contact rod 33 can have a significant length L (dimension measured parallel to the x-axis of an orthogonal coordinate system [O; x; y; z]), for example provided between 10 and 40 mm, in particular between 15 and 30 mm.

The central element 12 of the female contact 10 internally defines the inner axial housing 121 for receiving the male contact 30. This inner axial housing 121 has a complementary shape to that of the rod 33, with a preferably constant cross-section S1 (dimension measured orthogonally to the longitudinal axis A'A and parallel to the plane [O; x; y]). The inner axial housing 121a can thus have in particular the shape of a cylinder of revolution. The inner wall of the central element 12 delimiting this inner axial housing 121a is provided with a coating which is preferably smooth and made of a material that is a good electrical conductor, in particular a metallic material such as silver-plated copper.

As shown in the simplified view in FIG. 4 (in which the female contact 10 is shown alone), this central element 12 of the female contact 10 has a so-called “opening” area 121A through which the male contact 30 is designed to penetrate, and extends to a so-called “bottom” area 121B delimiting the inner housing and located opposite the opening area 121A. In order to adopt the position shown in FIGS. 1A-1B, the male contact 30 is inserted into the axial housing 121, passing through the opening area 121A before reaching the bottom area 121B.

Outside of the clamped position, the connector has play between the male contact 30 and an inner wall of the central element 12 of the female contact 10. This play, for example of the order of several tenths of a millimetre, is such that the two contacts 10, 30 can be fitted together whilst limiting friction, in particular at the start of the fitting phase.

The central element 12 of the female contact 10 may advantageously have a cut-out on a portion of its sides. This cut-out may be such that the portion of the central element 12 having the cut-out is provided with a plurality of fingers 129. Each 129 finger is called a “branch” and has a free end. The free end of each of the fingers is separate from the respective free ends of the other fingers 129. Such an arrangement gives the part 12 of the female contact 10 of the connector radial flexibility.

The fingers 129 may each have the shape of a portion of a cylinder of revolution. The free end of the fingers 129 is located at the “opening” area 121A, whilst another end, opposite the free end is attached to a foundation 128 of the central element 12, this foundation 128 forming the bottom area 121B of the inner axial housing.

One of the features of the female contact 10 here is in particular that it is provided with a part or an element separate from the central element 12 in the form of a ring 14 also known as a “sleeve” which is arranged around the central element 12 and is moveable relative to the central element 12. The ring 14 may move in translation in relation to this central element 12, in particular during a phase of inserting the male contact 30 in order to reach the so-called “clamped” position or during a phrase of removing the male contact 30.

The ring 14 is provided with an inner wall 143 designed to slide against an outer region 125 of the central element 12. This inner wall 143 of the ring 14 delimits an opening of constricted shape which is complementary to that of a profile of the outer region 125 of the central element 12.

The inner opening of the ring 14 has a cross-section S2 (dimension measured orthogonally to the longitudinal axis A'A and parallel to the plane [O; x; y] of an orthogonal coordinate system [O; x; y; z] which decreases with movement parallel to the longitudinal axis A'A from the opening area 121A towards the bottom area 121B. This constricted shape is advantageously frustoconical or conical. In this case, the outer region 125 of the central element 12 is shaped like a complementary cone or truncated cone. Such a shape limits the friction at the start of fitting the contacts together or during a disconnection phase when the male contact is about to leave the female contact.

When the contacts are fitted to achieve the clamped position, the ring 14 slides over the central element 12 of the female contact 10, itself having an external shape complementary to the cone of the ring 14. The clamping force on the male contact 30 therefore increases as the contact 12 moves in the ring 14. The angle of the cone is chosen so that the axial displacement of a few millimetres during the insertion and clamping of the connector results in great radial clamping with deformation of several tenths of a millimetre compensating for the initial play. The two conical surfaces in contact are preferably hard and smooth.

The ring 14 is connected here to the central element 12 by means of an elastic element 25 which may be in the form of at least one spring. The elastic element may in particular be arranged between an end edge 142 of the ring 14 and an outer region of the central element 12. The elastic element 25 may be a spring formed, for example, of type 316 stainless steel.

The elastic element 25 is designed to push the central element 12 of the ring 14. Thus, when the elastic element 25 is relaxed, the conical areas of the outer region 125 and of the inner wall 143, respectively of the central element 12 on the outside, and of the ring 14 on the inside, are not pressed against one another. As a result, there is no radial force induced on the surface 121 of element 12 and therefore no clamping on the part 33 of the male contact. When the element 25 is tightened, there is a gradual clamping force of the central element 12 on the male contact 30.

The elastic element 25 facilitates the release operation of the contact during which the male contact 30 is possibly to be removed from the female contact 10. When the contacts 10 and 30 are to be separated, the elastic element 25 ensures that the ring disengages from the outer region of the central element by releasing the pressure on the latter even before the female contact 10 begins to slide over the male contact 30.

The elastic element 25 typically in the form of a spring is provided with sufficient elongation to cover the travel of the ring 14, and sufficiently great stiffness which enables the ring 14 to be freed from the central element 12 of the female contact 10 whatever the previous clamping condition.

In the specific exemplary embodiment shown, the elastic element 25 is attached to a bulge 127, arranged on outer side walls of the central element 12 in particular at its fingers 129. The elastic element 25 may be connected to the ring 14 by means of a so-called “upper” edge 142 of the latter. The elastic element 25 therefore takes up a limited amount of space.

The connector is also typically provided with at least one case 60 for receiving the contacts. This case 60 may be formed by two distinct and separable main parts, a part 40 attached to the female contact 10 and a part 50 attached to the male contact 30.

The part 40 of the case 60 may be made, for example, at least at the inner surface, of insulating material such as a high-performance plastic, for example of polyether ether ketone, designated by the acronym PEEK, a KINEL® plastic, or such as a ceramic material.

The male contact 30 is typically surrounded by a part 50 of the case 60, forming an insulating envelope, at least at the inner surface in proximity of the contact 30, for example made of insulating material such as a high-performance plastic material, for example of polyether ether ketone, designated by the acronym PEEK, a KINEL® plastic, or such as a ceramic material, provided around its base 31.

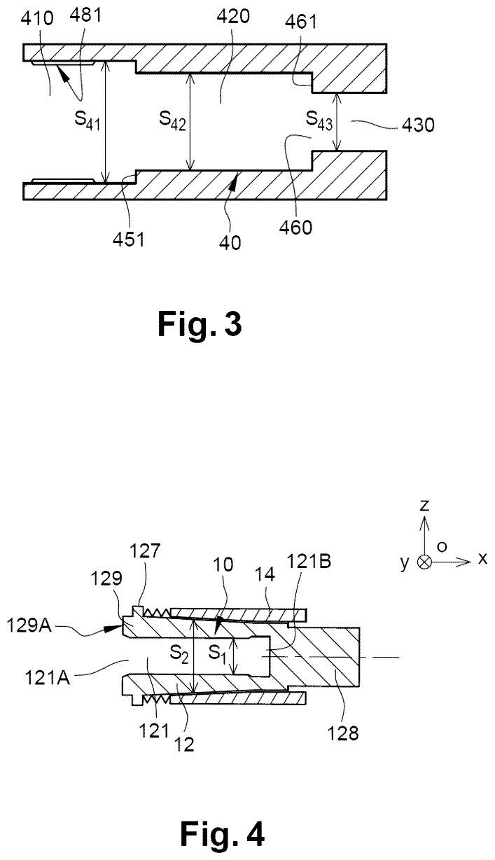

In this exemplary embodiment, and as shown in the partial view in FIG. 3 (where only the part 40 of the case 60 is shown), an inner space of the case 40 has a first volume 410 into which the envelope of the male contact 30 is intended to be inserted. In this case, the first volume 410 of the case 40 conforms to the shape of the assembly formed by the base 31 and the insulating envelope 50.

In the inner space of the part 40 of the case, a second volume 420 with a different section S42 from that S41 of the first volume 410 (S42 and S41 being dimensions measured parallel to the plane [O; x; y] of the coordinate system [O; x; y; z] and in this case smaller than that of the first volume 410, enables the female contact 10 to be housed. In this second volume 420, a part of the central element 12, having the inner housing for receiving the male contact, is arranged in particular.

In the inner space of the part 40 of the case, a third volume 430 narrower than the second volume 420 and arranged following the second volume 420 is provided to house the foundation 128 of the central element 12 of the female contact 10.

The part 40 of the case in this case has a stop area 461 around an interface area 460 between the second volume 420 and the third volume 430. The stop area 461 may be provided to stop the travel of the ring 14, in particular when the latter is subjected to a thrust from the elastic element 25 which is itself compressed by the central element 12 when the male contact 30 exerts a force on the latter.

At the change in section between the first volume 410 and the second volume 420, an offset at the inner wall of the part 40 of the case may form another stop 451 intended for its part to stop the male contact 30 when the latter is clamped.

Advantageously, the connector may be provided with a second elastic element 27. The second elastic element 27 typically in the form of at least one spring is arranged between the ring 14 and the part 40 of the case. This second elastic element 27 is used to compensate for the differential play and expansion in order to keep the ring 14 pressed against the central element 12 of the female contact 10. This spring is typically provided with low elongation and high stiffness. For example, the second elastic element 27 may made of type 316 stainless spring steel.

According to one possible arrangement, the second elastic element 27 is attached to the stop area 461 of the part 40 of the case. The second elastic element 27 may also be attached to a second end region 144 of the ring 14 opposite the one to which the elastic element 25 is attached.

The connector may be clamped by screwing. Thus, in the exemplary embodiment shown, the part 40 of the case has, on its inner walls and in the first inner volume 410, an internal thread 481 for receiving an external thread 51 produced on a peripheral part of the male contact 30, in particular on the envelope 50 arranged around the base 31.

It is the force supplied by an operator or a tool to lock the connector which brings the parts 50 and 40 of the case closer together and clamps them. And it is only once the two contacts are fully engaged and in abutment with each other, and not before, that the ring 14 slides over the element 12, compressing the elastic element 25 and tightening the element 12, causing the female contact to exert pressure on the male contact.

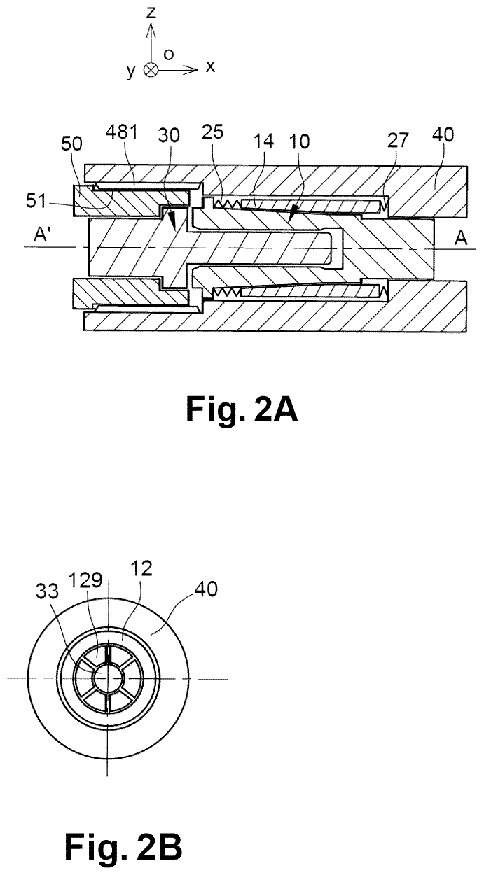

Between the clamped position and a released position shown in FIGS. 2A-2B, the female contact 10 moves axially relative to the part 40 of the connector case. When the male contact 30 or the part 50 of the case is unlocked or unscrewed, the central element 12 is pushed by the elastic element 25 towards the first volume 410 of the part 40 of the case 60.

In the released position, the upper end 122 of the central element 12 may thus protrude into the first volume 410 of the part 40 of the case whilst this upper end 122 is held in the second volume 420 of the part 40 of the case when the connector is in the clamped position.

An arrangement as described above may be applied to a single-pole contact as well as to a contact with a plurality of poles, each pole being formed by a combination of a male contact and a female contact.

An arrangement as described above may also be applied with a reversal of the internal and external threads between the parts 40 and 50 of the case 60, the part 50 then coming on top of the part 40.

1. An electrical connector comprising:
a female contact the female contact being provided:
with a central element internally defining an inner axial housing to receive a male contact
said inner axial housing extending along a longitudinal axis (A′A) and having a so-called opening area through which the male contact is designed to penetrate, and a so-called bottom area opposite which the male contact is designed to be located in a first position, known as the clamped position, of the connector, the female contact also being provided
with a ring arranged around said central element and separate from said central element, the ring being mounted so as to be moveable relative to the central element and arranged such that an inner wall of the ring is able to slide against an outer region of said central element,
said inner wall of the ring delimiting an opening of constricted shape, in particular frustoconical or conical, complementary to a profile of said outer region of the central element, said constricted shape having a cross-section which decreases with movement parallel to said longitudinal axis from the opening area towards the bottom area,
said ring being connected to the central element by means of an elastic element arranged between an end region of the ring and an outer region of the central element

2. The electrical connector according to claim 1, wherein the central element of the female contact is provided with a plurality of fingers defining at least part of the inner axial housing at its opening area each finger having a free end separate from the respective free ends of the other fingers and another end opposite the end and attached to a foundation.

3. The electrical connector according to claim 1, wherein the outer region of the central element has a bulge at an upper end of the central element said elastic element being arranged between said bulge and an upper edge of the ring.

4. The electrical connector according to claim 1, further comprising a male contact and wherein the male contact has:
a conductive base opposite which an upper edge of the central element of the female contact is intended to be arranged,
a conductive rod designed to penetrate said inner axial housing the conductive rod having a complementary shape to that of the inner axial housing, in particular a cylinder of revolution shape.

5. The electrical connector according to claim 1, further comprising a case the case being provided with a part having an inner space provided with a first volume into which the male contact is designed to be inserted and a second volume in which the female contact is designed to be housed and forming an envelope around said ring.

6. The electrical connector according to claim 5, wherein the ring is moveable relative to said part of the case and attached to said part of the case by means of a second elastic element.

7. The electrical connector according to 6, wherein the second elastic element is attached to a second end region of the ring opposite said end region and wherein the second volume of the part of the case is arranged between the first volume and a third volume which is narrower than the second volume,
said part of the case having a stop area around an interface area between the second volume and the third volume said stop area being provided at said narrowing, said second elastic element being attached to said stop area.

8. The electrical connector according to claim 5, wherein said part of the case has, in the first inner volume, an internal thread for receiving an external thread arranged laterally on the male contact or wherein the male contact is in a part of the case provided with a projecting area having an internal thread and the female contact in another part of the case having an external thread.

9. The electrical connector according to claim 8, wherein the base of the male contact is surrounded by a second part of the case made of insulating material and has said external thread.

10. The electrical connector according to claim 4, wherein the central element of the female contact is mounted to be moveable in said part of the case.

11. The electrical connector according claim 10 wherein in the clamped position, an upper end of the central element of the female contact is located in the second volume, and wherein in a released position, an upper end of the central element of the female contact extends into the first volume.

12. The electrical connector according to claim 1, wherein the male contact is received in the inner axial housing passing through the opening area before reaching the bottom area, the elastic element tending to push the central element of the ring when the male contact is pushed towards the bottom area of the inner axial housing of the female contact.

13. The electrical connector according to claim 6, wherein said part of the case has, in the first inner volume, an internal thread for receiving an external thread arranged laterally on the male contact or wherein the male contact is in a part of the case provided with a projecting area having an internal thread and the female contact in another part of the case having an external thread.

14. The electrical connector according to claim 6, wherein the central element of the female contact is mounted to be moveable in said part of the case.
